(19) United States
(12) Patent Application Publication
(10) Pub. No.: US 2014/0052791 A1
(43) Pub. Date: Feb. 20, 2014

(54) Task Based Filtering of Unwanted Electronic Communications

(71) Applicants: Al Chakra, Apex, NC (US); Mary K. Rees, Raleigh, NC (US); Michael S. Thomason, Raleigh, NC (US)

(72) Inventors: Al Chakra, Apex, NC (US); Mary K. Rees, Raleigh, NC (US); Michael S. Thomason, Raleigh, NC (US)

(73) Assignee: INTERNATIONAL BUSINESS MACHINES CORPORATION, Armonk, NY (US)

(21) Appl. No.: 13/584,850

(22) Filed: Aug. 14, 2012

(51) Int. Cl. G06F 15/16

(52) U.S. Cl. 709/206

(57) ABSTRACT

Mechanisms are provided for dynamically generating a task-based filter rule for filtering electronic communications. Characteristic data for at least one of electronic communications exchanged by, or user interactions performed via, a data processing system are collected. The characteristic data is automatically analyzed to determine if a task-based filter rule is to be generated. The task-based filter rule is automatically generated in response to determining that the characteristic data satisfies the dynamic task-based filter rule creation condition. Future electronic communications are automatically filtered by applying the task-based filter rule to the future electronic communications such that electronic communications satisfying a condition of the task-based filter rule are not filtered out.

### BACKGROUND

The present application relates generally to an improved data processing apparatus and method and more specifically to mechanisms for performing task based filtering of unwanted electronic communications

Electronic communication has become wide spread in modern society with the advent of the Internet, data communication networks, and the proliferation of computing devices. Electronic communications come in a variety of different types including electronic mail communications, instant message communications, web site postings, and the like. Along with the increase usage of electronic communications, an increase in the spread of unwanted electronic communications has also been experienced. For example, in the area of electronic mail (email) messages, unwanted and/or unsolicited electronic communications may be referred to as SPAM, junk email, or unsolicited bulk emails.

Because of the large increase in such unwanted electronic communications, many electronic communication applications have been developed with filters for filtering out these unwanted electronic communications. For example, with email applications, SPAM filtering is utilized to prevent electronic communications flagged as SPAM from being placed in a user's electronic inbox. Various rules may be utilized and set by the user for identifying SPAM which may include the use of whitelists and/or blacklists for specifying the senders, sender domains, and the like, that are authorized or unauthorized to send electronic communications to the particular user. Various types of SPAM filters are presently available.

### SUMMARY

In one illustrative embodiment, a method, in a data processing system, is provided for dynamically generating a task-based filter rule for filtering electronic communications. The method comprises collecting, by the data processing system, characteristic data for at least one of electronic communications exchanged by, or user interactions performed via, the data processing system. The method further comprises automatically analyzing, by the data processing system, the characteristic data to determine if a task-based filter rule is to be generated. A task-based filter rule is to be generated in response to the characteristic data satisfying a dynamic task-based filter rule creation condition. Furthermore, the method comprises automatically generating, by the data processing system, the task-based filter rule in response to determining that the characteristic data satisfies the dynamic task-based filter rule creation condition. Moreover, the method comprises automatically filtering, by the data processing system, future electronic communications by applying the task-based filter rule to the future electronic communications such that electronic communications satisfying a condition of the task-based filter rule are not filtered out.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is an example block diagram of a dynamic task-based filter engine in accordance with one illustrative embodiment;

FIG. 4 is an example diagram of a user interface for specifying creation/deletion criteria for determining when monitored characteristics indicate the need to create/delete a dynamic task-based filter rule in accordance with one illustrative embodiment;

FIG. 5 is a flowchart outlining an example operation for creating/deleting dynamic task-based filter rules in accordance with one illustrative embodiment; and

FIG. 6 is a flowchart outlining an example operation for applying a dynamic task based filter rule to an electronic communication in accordance with one illustrative embodiment.

### DETAILED DESCRIPTION

The illustrative embodiments provide mechanisms for task based filtering of unwanted electronic communications. With regard to the description of the illustrative embodiments, it will be assumed that the electronic communication is an electronic mail (email) message and the filtering is a task based SPAM filtering operation. However, it should be appreciated that the mechanisms of the illustrative embodiments may be implemented with regard to any type of electronic communication in which filtering of unwanted electronic communications is provided.

As mentioned above, current electronic communication applications have some limited functionality for identifying and filtering out unwanted communications, such as performing SPAM filtering. Such SPAM filtering does not recognize, however, that at some time in the future, a user's desire for the content of communications identified as SPAM may change and what was considered unwanted at one point may in fact become wanted. This change in user desire for content may be temporary, yet there is no mechanism currently available in known SPAM filters or other such filtering of electronic communications, for identifying if and when a user's desire for previously identified types of unwanted electronic communications changes or when such a change is no longer applicable, i.e. identifying if and when a user's needs change with regard to previously identified types of unwanted electronic communications.

As an example, assume that SPAM filtering has been set up to identify and filter out electronic communications that are from a particular sender or have certain keywords, or have characteristics indicative of mass distribution of the electronic communication. As a result, certain electronic messages associated with travel services may, under the current SPAM filtering operation, be filtered out as SPAM. However, a user may in fact be temporarily interested in travel services for assisting with the arrangements for a trip that the user is planning for the near future. As a result, certain electronic communications may be identified as SPAM under the current SPAM filter operations, and in general would not be of interest to the user, however at the present time may be of interest to the user because of the user's current desire to use travel services. Under current SPAM filtering mechanisms, there is no automated mechanism for identifying such a change in the user's desire to receive previously identified unwanted electronic communications and modify the operation of the SPAM filtering accordingly. Furthermore, there is no ability in known SPAM filtering mechanisms for automatically identifying when such a temporary change in user desire for previously identified unwanted communications is no longer valid and the previous operation of the SPAM filter may be restored. The illustrative embodiments provide mechanisms for performing such automated modification of filters of electronic communications based on tasks being performed by users, i.e. task based filtering of electronic communications. Moreover, the illustrative embodiments provide mechanisms to revive previously filtered out electronic communications that were previously indicated to be SPAM or the like within a user specified time frame.

With the illustrative embodiments, mechanisms are provided for monitoring the interactions a user has with various sources of content, social media services, electronic communication services, and the like, for interactions and/or communications meeting certain dynamic task-based filter rule creation criteria. If such dynamic task-based filter rule creation criteria are met, then a dynamic task-based filter rule is generated and applied to future electronic communications and possibly already filtered out electronic communications according to user settings. These dynamic task-based filter rules may have associated invalidation criteria or conditions that may further be monitored to determine if dynamic task-based filter rules should be disabled. While a dynamic task-based filter rule is applicable, it may supersede established electronic communication filters. When the dynamic task-based filter rule is disabled, the previously established filter operation is re-established such that filtering of the unwanted electronic communications is re-enabled.

A user may specify the conditions/criteria under which a dynamic task-based filter rule is created. For example, a user may define a rule that identifies conditions identifying patterns in the user's interactions and/or electronic communications that indicate when a new dynamic task-based filter rule is to be created and applied to future electronic communications and/or previously filtered electronic communications. Similarly, the user may specify the conditions/criteria under which a dynamic task-based filter rule is to be disabled. These conditions/criteria may be applied to data collected by monitoring mechanisms to determine when such conditions/criteria are met by the user's interactions/electronic communications. This monitoring, creation of dynamic task-based filter rules, application of the dynamic task-based filter rules to electronic communications, and disabling of dynamic task-based filter rules may be performed automatically without user intervention. The user intervention may be limited to specifying the conditions/criteria for generating and disabling the dynamic task-based filter rules. In some illustrative embodiments, users may be prompted before enabling/disabling of the dynamic task-based filter rules.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wired, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

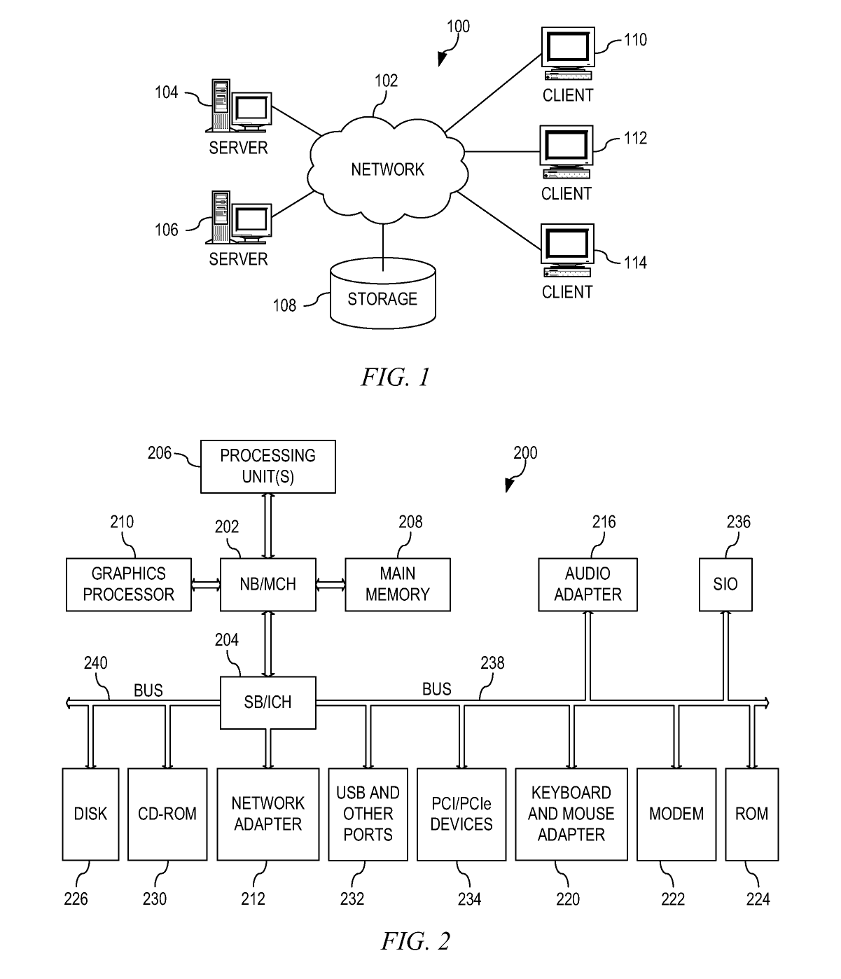

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

Referring again to FIG. 1, a client computing device, such as client computing device 110, 112, or 114, may be equipped with one or more software applications through which a user may generate and exchange electronic communications with other computing devices as well as interact with other computing devices, such as servers 104, 106, which provide services with which the users of the client computing devices 110, 112, or 114 may interact and/or subscribe. The client device, e.g., client device 110, may further be equipped with the mechanisms of the illustrative embodiments for monitoring the user's interactions and electronic communications (both to and from the client computing device 110) for content indicative of conditions/criteria being met for dynamic creation of task-based filter rules. These mechanisms may be generally referred to herein as a dynamic task-based filter engine for electronic communications. The dynamic task-based filter engine may operate as an integrated module of an existing electronic communication application, e.g., an electronic mail client application, a computing network application, such as an Internet browser application or the like, or other application for interfacing with or otherwise communicating via electronic communication with other computing devices. Alternatively, the dynamic task-based filter engine may be a plug-in module to these types of communication/interface applications, may be a separate engine which operates in conjunction with agent modules provided in these communication/interface applications, or the like.

The dynamic task-based filter engine operates to monitor electronic communications sent/received by the client device 110 and user interactions with other computing devices via the network interface application to identify subjects or topics of interest to the user. For example, keywords may be extracted from the electronic communications (e.g., subject lines, body text, and/or the like), extraction of search terms entered into a search engine, hypertext markup language tags may be extracted from associated websites, tags associated with images or multimedia content accessed via the network interface application, or the like, and may be used to represent these subjects or topics of interest to the user, natural language recognition mechanisms may identify important words/phrases in a user's speech input, such as via a voice-over-IP (VoIP) mechanism or the like, obtaining a description of a website that the user selects to subscribe to, performing image recognition on content of a website with which the user interacts and determining a content of the recognized image. Any of a plethora of other mechanisms for identifying interests of a user, as will be apparent to those of ordinary skill in the art in view of the present description, may be used without departing from the spirit and scope of the illustrative embodiment.

The dynamic task-based filter engine collects data representing characteristics of the electronic communications and user interactions and logs this characteristic information for analysis to determine if dynamic task-based rule creation/deletion criteria are met. If such dynamic task-based rule creation/deletion criteria are met, then the dynamic task-based filter engine performs the necessary operations to automatically create or delete dynamic task-based filter rules for filtering electronic communications. While such dynamic task-based rules are valid, these dynamic task-based filter rules may supersede existing filters used by electronic communication/network interface applications, e.g., junk mail filter rules, whitelists, blacklists, SPAM filtering, pop-up blockers, etc.

Thus, with the mechanisms of the illustrative embodiments, a user's current interests are automatically determined by analyzing their communications and interactions via their client computing device. Based on the identified interests, task-based filtering rules are automatically generated in a dynamic manner to supersede existing (default) filtering rules so as to allow/deny electronic communications, retrieval of electronic content, or the like, associated with a task corresponding to the identified user interest, via electronic communication/network interface applications. These dynamically generated task-based filter rules may be automatically invalidated or deleted in response to an automatic determination that the task has been completed. This automatic invalidation or deletion may be predicated on an analysis of the user's communications and interactions via the client computer indicating that the user is no longer interested in the task or actual indications that the task has been completed.

As an example scenario, to better illustrate the operation of the illustrative embodiments, consider a situation in which a user, Mary, utilizes an electronic mail (email) application that has a SPAM filter enabled so as to filter out electronic mail messages that meet criteria indicative of the electronic mail message being SPAM, i.e. an unwanted and/or unsolicited electronic mail message that is not of interest to Mary. Via this SPAM filter, SPAM emails of different context are blocked since Mary does not communicate with the senders of these SPAM emails or otherwise has indicated that Mary does not wish to receive communications of the particular type or from the particular sender (e.g., the sender is placed on a blacklist associated with the SPAM filter).

As part of the filtering performed by the SPAM filter, however, emails from certain furniture stores/companies are filtered out because they meet the criteria of the SPAM filter as being SPAM, e.g., have the word “sale” in the subject line, have certain hyperlinks in the body of the emails, or any other standard SPAM filter criteria. SPAM filtering is generally known in the art and thus, a more detailed explanation of the processes used for identifying SPAM using such SPAM filters is not provided herein.

However, while this SPAM filter is still operating, Mary may decide that she is in the market for patio furniture. Under normal operation of the SPAM filter, the emails from the furniture stores/companies are automatically filtered out and Mary would not have any knowledge that such emails have been sent to her even though she may be interested in seeing these emails. Mary's interest in patio furniture may be automatically identified by the mechanisms of the illustrative embodiments by detecting keywords, such as “patio furniture,” “purchase,” or the like, in electronic mail messages received/sent by Mary from/to other users, Mary's web browsing history and the keywords associated with the websites visited by Mary within a predetermined time period, web searches performed via search engines, user interactions to subscribe to email distribution lists of particular websites, etc.

Based on this automatic identification of Mary's interest, log records are created that store the characteristics of Mary's communications/interactions regarding the interest in patio furniture. That is, a record may be generated for “patio furniture” in a log data structure, and corresponding counts of numbers of electronic mail messages within a predetermined period of time may be collected, numbers of interactions, the natures of the interactions, and the like, within a predetermined period of time may also be collected, timestamps associated with such communications/interactions, and other characteristic data may be collected for determining the amount and nature of the user's communications/interactions regarding the particular subject/topic of interest.

The log records may be periodically, continually, or in response to certain events, analyzed in accordance with user defined conditions/criteria for the automatic creation/deletion of dynamic task-based filter rules. That is, a user interface may be provided by the dynamic task-based filter engine through which the user may specify the criteria/conditions that trigger the creation/deletion of dynamic task-based filter rules. For example, the criteria/conditions may include “I have searched more than ‘x’ times per week for ‘y’” where “x” is a user specified integer value and “y” is the particular identified topic/subject of interest to the user, e.g., patio furniture in this example scenario. As another example, a criteria/condition may be that “I have not searched in the past ‘x’ days for ‘y’” where “x” is again a user specified integer value and “y” is the particular identified topic/subject of interest to the user. Many types of criteria/conditions may be provided and enabled/disabled via the user interface without departing from the spirit and scope of the illustrative embodiments; more examples will be provided hereafter.

Should the analysis of the log records indicate that one or more of the conditions/criteria for creating/disabling dynamic task-based filter rules have been met, then the corresponding operation is performed by the dynamic task-based filter engine. Thus, for example, assume that Mary has searched for patio furniture 10 or more times in the last week thereby triggering dynamic task-based filter rule creation due to the condition/criteria “I have searched more than 10 times per week for patio furniture” having been met. As a result, a new dynamic task-based filter rule may be generated that essentially states that electronic communications having the subject matter of “patio” or “furniture” are permitted to be received by the user via their electronic communication application. This essentially supersedes the default SPAM filter of the email application which initially may flag an electronic communication from Robert's Furniture as SPAM but then allows the electronic mail message from Robert's Furniture to pass without being flagged as SPAM due to the application of the dynamic task-based filter rule.

At some point in the future, electronic communications sent to/from Mary via the electronic communication application may indicate that Mary has completed the task of purchasing patio furniture. This may include, for example, an invoice sent from a furniture store indicating patio furniture has been purchased, an email from Mary to a friend indicating that she has bought new patio furniture, or the like. Moreover, a lack of communication or user interaction with websites or other sources of content within a predetermined period of time may be indicative of Mary's change in interests such that Mary is no longer interested in purchasing patio furniture, either because she has already completed the task by purchasing patio furniture or because she simply is no longer interested in purchasing patio furniture. In such a case, in response to these conditions/criteria being met indicating a lack of interest in a particular subject/topic for which a dynamic task-based filter rule is currently valid, then appropriate operations are performed for invalidating the dynamic task-based filter rule, and/or deleting the dynamic task-based filter rule, such that it is no longer applied to future electronic communications (emails). As a result, the established (default) SPAM filter rules are applied and emails that were previously allowed to come through to the user due to the application of the dynamic task-based filter rule may again be filtered out by the established SPAM filter rules of the electronic communication application, e.g., emails from Robert's Furniture are again filtered out when it is determined that Mary is no longer interested in purchasing patio furniture.

Moreover, in some illustrative embodiments, the establishment of a dynamic task-based filter rule may be applied retroactively to electronic communications previously received at the user (e.g., Mary in the example above) client computing device and which were previously filtered out by the existing SPAM filter rules. That is, the mechanisms of the illustrative embodiments may be customized according to user specified settings to apply to previously filtered out electronic communications within a specified period of time from a current time. In such an embodiment, a known location of filtered out electronic communications, e.g., a trash folder, deleted messages folder, or the like, may be analyzed using the newly created dynamic task-based filter rule to revive previously filtered out electronic messages that meet the criteria of the newly created dynamic task-based filter rule, i.e. would be allowed to be output to the user if it were newly received after implementation of the newly created dynamic task-based filter rule. The range of messages considered for such revival may be limited by a user specified setting of a time range from a current time, for example, such that only electronic messages having a receipt date within the specified time range are considered, e.g., only messages received within the last day, week, month, etc. This revival analysis will only consider electronic messages that are still capable of being revived, i.e. electronic messages that have been actually deleted and not just placed in a delete or trash folder cannot be revived.

Thus, with the illustrative embodiments, the basic functionality of SPAM filters and other electronic communication filters may be dynamically modified in accordance with the automatically determined interests and tasks that a user is currently involved in so as to allow certain communications that would otherwise be filtered out as SPAM may in fact be allowed to pass through the SPAM filter to reach the user. Similarly, the illustrative embodiments may automatically determine when such interests/tasks are no longer relevant, e.g., the task has been completed, the user's interest has waned, or the like, and as a result, the dynamic modifications to the SPAM filter or other electronic communication filter may be reversed, invalidated, or otherwise made no longer applicable to electronic communications.

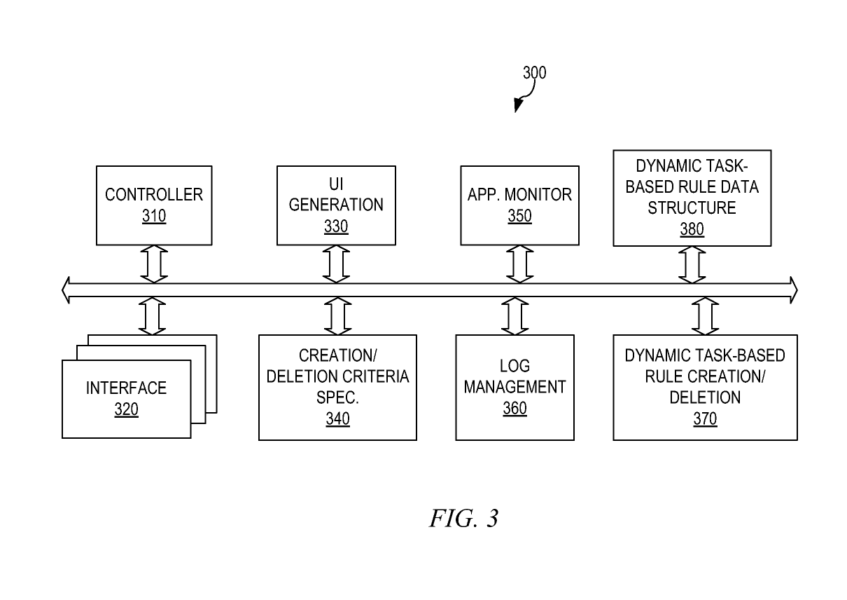

FIG. 3 is an example block diagram of a dynamic task-based filter engine in accordance with one illustrative embodiment. The elements shown in FIG. 3 may be implemented in software, hardware, or any combination of software and hardware. For example, in one illustrative embodiment, the elements shown in FIG. 3 are implemented as software instructions executed by one or more processors on one or more computing systems. Of course, dedicated hardware logic may be provided either in the alternative or in combination with software mechanisms, to implement one or more of the elements shown in FIG. 3. For purposes of the following description, it will be assumed that the elements in FIG. 3 are implemented as software instructions executed by one or more processors.

As shown in FIG. 3, the dynamic task-based filter engine 300 comprises a controller 310, one or more application interfaces 320, a user interface generation component 330, a creation/deletion criteria specification component 340, an application monitoring component 350, a log management component 360, a dynamic task-based rule creation/deletion component 370, and a dynamic task-based rule data structure 380. The controller 310 controls the overall operation of the dynamic task-based filter engine 300 and orchestrates the operation of the other elements 320-380 of the dynamic task-based filter engine 300. The one or more application interfaces 320 provide a communication pathway, logic, and the like, for interfacing with electronic communication applications, network applications, and the like, to monitor a user's interactions with these applications and/or monitor the content, subject matter, and the like, of electronic communications the user of the computing device exchanges with other users.

The user interface generation component 330 generates one or more user interfaces through which a user may specify creation/deletion criteria for determining when dynamic task-based filter rules are to be created and/or deleted/invalidated. In addition, any other user interfaces that may be used with the operation of the dynamic task-based filter engine 300 may also be generated by the user interface generation component 330. For example, in some illustrative embodiments, before a dynamically created task-based filter rule is enabled (created or validated) or disabled (deleted or invalidated), a user interface may be displayed to a user through which the user may indicate agreement with or disagreement with the enablement/disabling of the dynamically created task-based filter rule.

The creation/deletion criteria specification component 340 provides the logic for defining the creation/deletion criteria to be applied to characteristic data collected from the monitoring of electronic communications and user interactions via interfaces 320. The creation/deletion criteria specification component 340 may work in concert with the user interface generation component 330 to output options for defining creation/deletion criteria for specifying the triggering conditions/criteria for creating and/or deleting dynamic task-based filter rules. The creation/deletion criteria specification component 340 may receive user input via these user interfaces and use the user input to establish one or more creation/deletion criteria specifications that are stored in association with the application monitoring component 350. The operation of the creation/deletion criteria specification component 340 may be initiated by a user, for example, requesting the ability to define such creation/deletion criteria.

The application monitoring component 350 monitors the electronic communications being exchanged via one or more electronic communication applications (e.g., email applications), user interactions with network interfaces (e.g., a web browser application), and the like. The monitoring includes analyzing the electronic communications and user interactions for indications of topics/subjects/content of interest to the user associated with a task that the user wishes to accomplish, e.g., purchasing an item, obtaining more information about a subject, acquiring/utilizing a service, etc. The analysis performed is dependent upon the type of electronic communication and user interaction being analyzed. For example, with regard to text-based electronic communications, such analysis may include, for example, identifying keywords in the electronic communications and user interactions. For user interactions with websites and other network based sources of content, such analysis may include determining descriptive text associated with images clicked on by the user, registrations made by the user, search terms entered into search engines, keywords in postings to message boards or newsgroups, determining what video, audio, or multimedia content a user views or listens to (which may be determined from titles, descriptions, user comments, or specific tags associated with the video), or the like. Other types of analysis may be performed for identifying which electronic communications/user interactions contain subjects, topics, or content of interest to the user with regard to the generation of dynamic task-based filter rules without departing from the spirit and scope of the illustrative embodiments.

Based on the analysis indicating that the electronic communication/user interaction corresponds to a subject/topic/content or interest to the user, characteristics about the electronic communication/user interaction are collected and used to generate a new record, or update information in an existing record, in a log data structure maintained by the log management component 360. That is, the log data structure is first searched by the log management component 360 to determine if there is a corresponding record in the log data structure corresponding to the subject/topic/content identified in the electronic communication/user interaction. The characteristic information that is extracted from the electronic communication/user interaction and used to create the new record or update the existing record may take many different forms including a timestamp, parties involved in the electronic communication/user interaction, a nature of the electronic communication/user interaction (e.g., email, web search, etc.), or the like. This information may be used to update or set the values of counters in a corresponding record of the log data structure, store information about a last electronic communication/user interaction associated with the subject/topic/content (e.g., a timestamp of a last electronic communication/user interaction), or the like. Thus, for example, the record may store a count of a number of times, within a predetermined time period of the current time, that the user has communicated with others or interacted with a web based source of content with regard to the particular subject/topic/content. The timestamps associated with such communications/user interactions may be used to determine which ones should be included in such determinations and thus, how many should be considered.

The dynamic task-based rule creation/deletion component 370 analyzes the records in the log data structure maintained by the log management component 360 to determine when one or more of the records meet user defined criteria for creating/deleting a dynamic task-based filter rule. For example, if the log record indicates that the user has searched for patio furniture 10 times within the last 7 days, then a dynamic task-based filter rule associated with patio furniture may be automatically created. Similarly, if the log record indicates that the user has not searched for patio furniture in the last 14 days, then any existing dynamic task-based filter rule associated with patio furniture may be automatically invalidated and/or deleted. The particular conditions/criteria for determining when to create/delete such dynamic task-based filter rules may take many different forms depending upon the implementation.

The dynamic task-based rule data structure 380 stores the dynamic task-based rules created by the dynamic task-based rule creation/deletion component 370 for use by filter mechanisms when determining whether to filter out electronic communications before presenting them to a user or otherwise placing them in a location on the computing device where they may be accessed by the user. The dynamic task-based filter rules may be integrated into the existing filter mechanisms' rule database. For example, if an email program is being utilized, then the SPAM filter may have its rule database updated to include the dynamically created task-based filter rules. In such a case, the SPAM filter is augmented to implement logic that determines the relative priority of filter rules such that the new dynamically created task-based filter rules are given priority over other filter rules. In this way, even if the SPAM filter's rules would flag an email as SPAM, the dynamically created task-based filter rules may supersede these existing SPAM filter rules and instead allow the email to pass through the SPAM filter without being flagged as SPAM.

Alternatively, the application of the dynamic task-based filter rules may be performed by the dynamic task-based filter engine 300 as a separate entity from the filter mechanisms associated with the electronic communication applications of the computing device with which the dynamic task-based filter engine 300 is associated or on which the engine 300 is executed. In such a case, the engine 300 may interface with the filter logic of the electronic communication application to receive information about electronic communications flagged as electronic communications to be blocked, e.g., SPAM, and then may further analyze them according to the currently valid dynamically created task-based filter rules to determine if these electronic communications should be allowed to pass through the filter logic of the electronic communication application. This embodiment may utilize plug-in modules or the like, that may be plugged-into the electronic communications applications to facilitate an interface between the electronic communications application and the dynamic task-based filter engine 300.

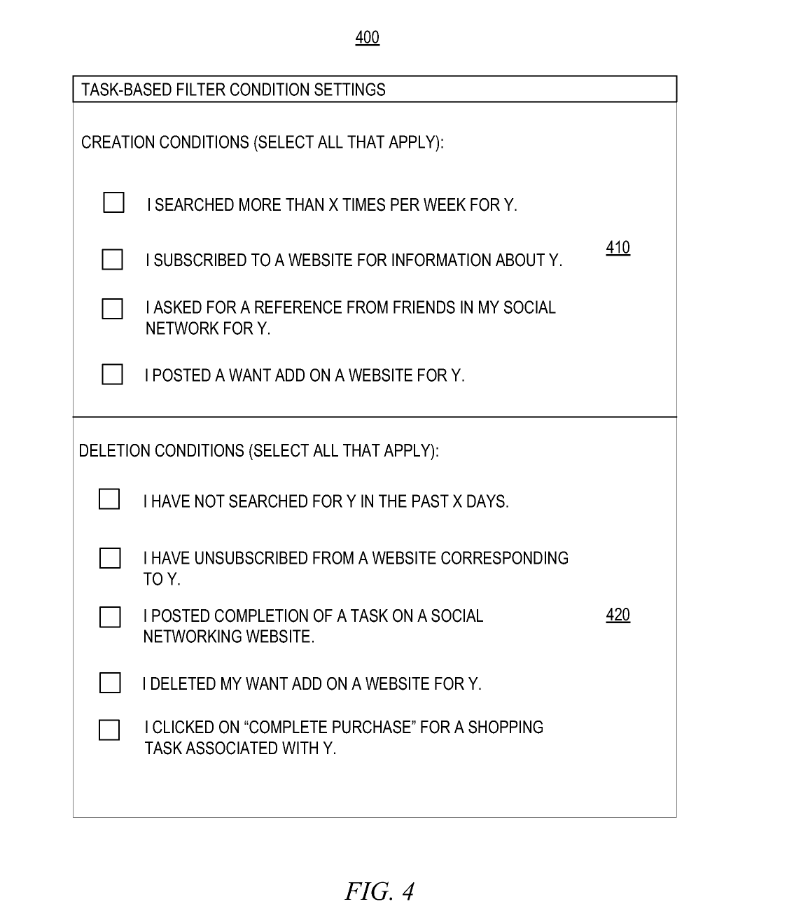

As discussed above, the illustrative embodiments may provide a user interface through which a user may specify the criteria/conditions under which a dynamically created task-based filter rule is to be generated. FIG. 4 is an example diagram of a user interface for specifying creation/deletion criteria for determining when monitored characteristics indicate the need to create/delete a dynamic task-based filter rule in accordance with one illustrative embodiment. As shown in FIG. 4, there are a plurality of possible conditions/criteria 410 provided for specifying when a dynamic task-based filter rule should be created. Similarly, there are a plurality of possible conditions/criteria 420 provided for specifying when a dynamic task-based filter rule should be disabled, invalidated, deleted, or otherwise made no longer applicable to electronic communication filtering. A user may utilize the interface 400 to select one or more of the conditions/criteria. Based on the user's selections, a corresponding creation/deletion rule is generated and stored for application to future electronic communication and user interface analysis.

It should be appreciated that the task-based filter rules may be of various levels of complexity and a plurality of these task-based filter rules may be utilized together to achieve the purposes of the illustrative embodiments. That is, a task-based filter rule may set forth a single or a plurality of criteria that may be combined in a variety of different ways, such as via the use of Boolean operators or the like, to define a general or specific interest of the user as determined from the user's interactions and communications. Thus, for example, a task-based filter rule may simply specify that all electronic communications associated with “Italy” are to be allowed to pass through the SPAM filtering of the electronic mail program. However, this may not be specific enough for the particular user's interests and instead a more specific dynamic task-based filter rule may be generated, based on the analysis of the user's interactions and communications, of a type that only communications about “Italy” and “guided tours” are to be allowed through the SPAM filtering. As such, some communications about Italy that are not concerned with “guided tours” will be filtered out while other communications concerned with Italy and guided tours will be allowed to pass through the SPAM filtering.

It should be appreciated that instead of having a single dynamic task-based filter rule that has multiple criteria, multiple rules may be combined and applied to achieve a similar purpose, e.g. a first rule having “Italy” as the criteria and a second rule having “guided tours” as a criteria. The manner by which criteria within rules and rules themselves are combined is implementation specific but can be performed in any suitable manner readily apparent to those of ordinary skill in the art in view of the present description.

In still a further embodiment, communications may be scored based on the particular criteria/rules satisfied by the characteristics of the communication. The score may then be compared to a user specified threshold setting that defines when a communication is determined to be sufficiently matching of the user's interests to warrant allowing the communication to pass the default SPAM filtering of the electronic communication application (email application or the like). The scoring may be based on weightings associated with different criteria/rules, for example, which may be automatically generated based on analysis of the user's interactions/communications and/or may be user specified. For example, the weightings may be automatically determined based on a frequency of detection of the criteria in the user's interactions/communications, where more frequently detected criteria have a higher weighting.

For example, if a user has repeatedly communicated about, and interacted with websites dealing with, patio furniture, then the “patio furniture” criteria or a rule specifying “patio furniture” may have a higher weighting than another criteria or rule dealing with “wicker” which may have been detected less frequently in a user's interactions/communications. Thereafter, if a new communication is received that deals with “patio furniture” then it will have a first score based on the weighting for “patio furniture.” If a second new communication is receive that deals with “wicker patio furniture,” then this second new communication may have a higher score than the first communication because it meets a larger number of criteria/rules or meets criteria/rules having a higher weighting than the first communication. This score can then be compared against a user specified threshold value such that if the threshold value is met or exceeded, then the communication is permitted to pass SPAM filtering.

As mentioned previously, not only does the dynamic task-based filter rule apply to newly received electronic communications, but in some illustrative embodiments these dynamic task-based filter rules may be applied to previously received electronic communications that were previously filtered out by the SPAM filtering or the like. Thus, previously filtered out communications may be revived and presented to the user if they meet the criteria of the dynamic task-based filter rule or rules and would be passed through the SPAM filtering if the communication were a newly received communication.

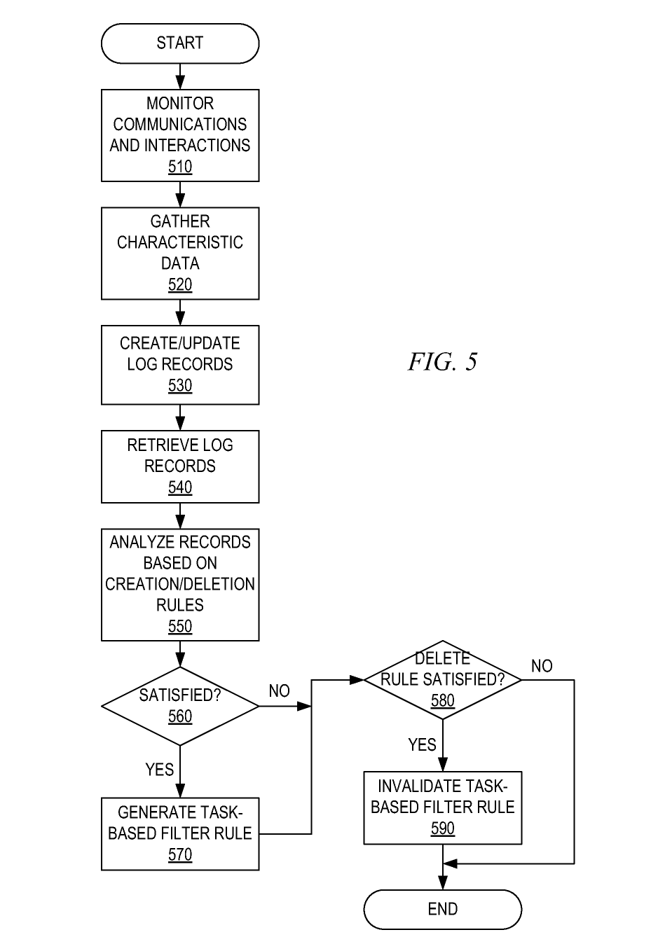

FIG. 5 is a flowchart outlining an example operation for creating/deleting dynamic task-based filter rules in accordance with one illustrative embodiment. The operation outlined in FIG. 5 may be implemented, for example, by the dynamic task-based filter engine 300 in FIG. 3.

As shown in FIG. 5, the operation starts monitoring electronic communications and user interactions associated with a user via the user's computing device (step 510). Characteristic data for describing the electronic communication/user interaction is gathered for those electronic communications/user interactions determined to be associated with a subject/topic/content of interest to the user with regard to task-based filtering (step 520). The characteristic data is used to create new records in a log data structure and/or update existing records in the log data structure (step 530). Thereafter, at a predetermined time, continuously, or in response to a given event, records of the log data structure are retrieved from a log data structure storage (step 540). The records of the log data structure are analyzed according to one or more established creation/deletion rules (step 550). A determination is made as to whether the condition of a creation rule is satisfied (step 560). If so, then a corresponding dynamic task-based filter rule for the subject/topic/content of the corresponding record is generated and stored (step 570). This is done for each such creation rule whose conditions are satisfied and for each record in the log data structure that meets such conditions.

A determination is made as to whether the condition of a deletion rule is satisfied (step 580). If so, then a corresponding dynamic task-based filter rule for the subject/topic/content is invalidated/deleted (step 590). This is done for each such deletion rule whose deletion conditions are satisfied. The operation then terminates.

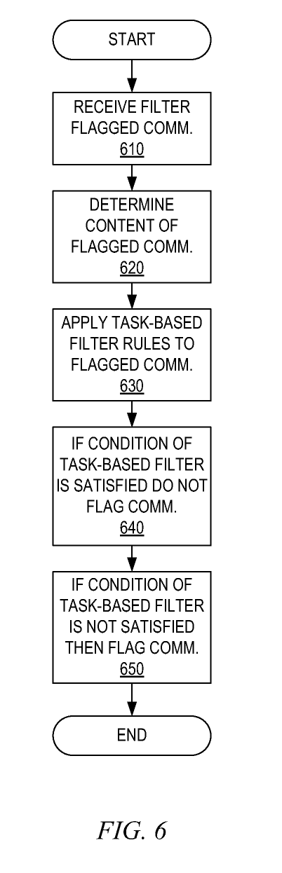

FIG. 6 is a flowchart outlining an example operation for applying a dynamic task based filter rule to an electronic communication in accordance with one illustrative embodiment. The operation outlined in FIG. 6 may be implemented, for example, by the dynamic task-based filter engine 300 in FIG. 3.

As shown in FIG. 6, the operation starts by receiving an indication of an electronic communication that has been flagged as one to be filtered out by a default or standard filter of an electronic communication application (step 610). A subject/topic/content of the flagged electronic communication is determined (step 620). One or more dynamic task-based filter rules are applied to the flagged electronic communication to determine if the flagged electronic communication meets the criteria/condition of the dynamic task-based filter, e.g., if the flagged electronic condition is directed to patio furniture, then the condition of a dynamic task-based filter that states that electronic communications about patio furniture are not SPAM would be satisfied (step 630). If the condition of a dynamic task-based filter is satisfied, then the electronic communication is not flagged for filtering out (step 640). If the condition of a dynamic task-based filter is not satisfied, then the electronic communication is allowed to be flagged for filtering out and is thus, filtered out by the filter mechanisms of the electronic communication application (step 650). The operation then terminates.

Thus, the illustrative embodiments provide mechanisms for automatically, and dynamically, generating task-based filter rules based on the automatically identified interests of the user. These mechanisms automatically determine the interests of the user from analysis of the user's electronic communications and user interactions and then generates the task-based filter rules that are applied while the mechanisms of the illustrative embodiments determine that the user has this interest. The mechanisms of the illustrative embodiments may also automatically determine when the user's interests have changed and previously applicable task-based filter rules are not longer valid. In such a case, the previously generated dynamic task-based filter rules may then be invalidated and/or deleted such that they are no longer applied to future electronic communications. In this way, automated overriding of default electronic communication filters may be determined and applied and then withdrawn as determined to be necessary.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for dynamically generating a task-based filter rule for filtering electronic communications, comprising:
collecting, by the data processing system, characteristic data for at least one of first electronic communications exchanged by, or user interactions performed via, the data processing system;
automatically analyzing, by the data processing system, the characteristic data to determine if a task-based filter rule is to be generated, wherein a task-based filter rule is to be generated in response to the characteristic data satisfying a dynamic task-based filter rule creation condition;
automatically generating, by the data processing system, the task-based filter rule in response to determining that the characteristic data satisfies the dynamic task-based filter rule creation condition; and
automatically filtering, by the data processing system, second electronic communications by applying the task-based filter rule to the future electronic communications such that electronic communications satisfying a condition of the task-based filter rule are not filtered out.

2. The method of claim 1, wherein the characteristics data specifies topics or subjects of interest to a user of the data processing system.

3. The method of claim 2, wherein the characteristics data specifies the topics or subjects of interests by keywords extracted from the first electronic communications or user interactions.

4. The method of claim 1, wherein the task-based filter rule supersedes default filter rules of a filtering engine executed by the data processing system to allow second electronic communications meeting criteria of the task-based filter to be output to a user even though the second electronic communications would otherwise be filtered out by the default filter rules.

5. The method of claim 1, wherein the first electronic communications exchanged by the data processing system comprises at least one of electronic mail messages sent by the data processing system, instant messages sent by the data processing system, or messages posted to a network site, and wherein the user interactions performed via the data processing system comprises at least one of entry of search terms into a search engine, selection of hypertext on a network site, viewing of images or multimedia content on a network site, or voice input via the data processing system.

6. The method of claim 1, wherein the second electronic communications comprise previously filtered out electronic communications that were previously filtered out by a filter engine executed on the data processing system according to default filter rules.

7. The method of claim 1, further comprising:
automatically analyzing, by the data processing system, the characteristic data to determine if a task-based filter rule is to be deleted, wherein a task-based filter rule is deleted in response to the characteristic data satisfying a dynamic task-based filter rule deletion condition.

8. The method of claim 7, wherein the dynamic task-based filter rule deletion condition comprises a lack of first electronic communications, or user interaction via the data processing system, regarding a criteria specified in the task-based filter rule within a predetermined period of time.

9. The method of claim 1, wherein automatically filtering second electronic communications by applying the task-based filter rule to the future electronic communications comprises:
generating a score for a second electronic communication based on a correspondence of characteristics of the second electronic communication with criteria specified in the task-based filter rule, and at least one weighting value associated with the task-based filter rule;
comparing the score for the second electronic communication to at least one threshold value; and
in response to the at least one threshold value being met or exceeded by the score for the second electronic communication, allowing the second electronic communication to be output to a user of the data processing system.

10. The method of claim 9, wherein the at least one weighting value is associated with at least one of the task-based filter rule as a whole, or individual criteria within the task-based filter rule.

11. A computer program product comprising a computer readable storage medium having a computer readable program stored therein, wherein the computer readable program, when executed in a data processing system, causes the data processing system to:
collect characteristic data for at least one of first electronic communications exchanged by, or user interactions performed via, the data processing system;
automatically analyze the characteristic data to determine if a task-based filter rule is to be generated, wherein a task-based filter rule is to be generated in response to the characteristic data satisfying a dynamic task-based filter rule creation condition;
automatically generate the task-based filter rule in response to determining that the characteristic data satisfies the dynamic task-based filter rule creation condition; and
automatically filter second electronic communications by applying the task-based filter rule to the future electronic communications such that electronic communications satisfying a condition of the task-based filter rule are not filtered out.

12. The computer program product of claim 11, wherein the characteristics data specifies topics or subjects of interest to a user of the data processing system.

13. The computer program product of claim 12, wherein the characteristics data specifies the topics or subjects of interests by keywords extracted from the first electronic communications or user interactions.

14. The computer program product of claim 11, wherein the task-based filter rule supersedes default filter rules of a filtering engine executed by the data processing system to allow second electronic communications meeting criteria of the task-based filter to be output to a user even though the second electronic communications would otherwise be filtered out by the default filter rules.

15. The computer program product of claim 11, wherein the first electronic communications exchanged by the data processing system comprises at least one of electronic mail messages sent by the data processing system, instant messages sent by the data processing system, or messages posted to a network site, and wherein the user interactions performed via the data processing system comprises at least one of entry of search terms into a search engine, selection of hypertext on a network site, viewing of images or multimedia content on a network site, or voice input via the data processing system.

16. The computer program product of claim 11, wherein the second electronic communications comprise previously filtered out electronic communications that were previously filtered out by a filter engine executed on the data processing system according to default filter rules.

17. The computer program product of claim 11, wherein the computer readable program further causes the data processing system to:
automatically analyze the characteristic data to determine if a task-based filter rule is to be deleted, wherein a task-based filter rule is deleted in response to the characteristic data satisfying a dynamic task-based filter rule deletion condition.

18. The computer program product of claim 17, wherein the dynamic task-based filter rule deletion condition comprises a lack of first electronic communications, or user interaction via the data processing system, regarding a criteria specified in the task-based filter rule within a predetermined period of time.

19. The computer program product of claim 11, wherein the computer readable program causes the data processing system to automatically filter second electronic communications by applying the task-based filter rule to the future electronic communications by:
generating a score for a second electronic communication based on a correspondence of characteristics of the second electronic communication with criteria specified in the task-based filter rule, and at least one weighting value associated with the task-based filter rule;
comparing the score for the second electronic communication to at least one threshold value; and
in response to the at least one threshold value being met or exceeded by the score for the second electronic communication, allowing the second electronic communication to be output to a user of the data processing system.

20. An apparatus, comprising:
a processor; and
a memory coupled to the processor, wherein the memory comprises instructions which, when executed by the processor, cause the processor to:
collect characteristic data for at least one of first electronic communications exchanged by, or user interactions performed via, the data processing system;
automatically analyze the characteristic data to determine if a task-based filter rule is to be generated, wherein a task-based filter rule is to be generated in response to the characteristic data satisfying a dynamic task-based filter rule creation condition;
automatically generate the task-based filter rule in response to determining that the characteristic data satisfies the dynamic task-based filter rule creation condition; and
automatically filter second electronic communications by applying the task-based filter rule to the future electronic communications such that electronic communications satisfying a condition of the task-based filter rule are not filtered out.
